(19) United States
(12) Patent Application Publication
(10) Pub. No.: US 2024/0421930 A1
(43) Pub. Date: Dec. 19, 2024

(54) TIME SYNCHRONIZATION DEVICE, TIME SYNCHRONIZATION METHOD, AND PROGRAM

(71) Applicant: NIPPON TELEGRAPH AND TELEPHONE CORPORATION, Tokyo (JP)

(72) Inventors: Keisuke YAMAGATA, Tokyo (JP); Shinichi YOSHIHARA, Tokyo (JP); Go YAZAWA, Tokyo (JP); Takashi NAKANISHI, Tokyo (JP)

(73) Assignee: NIPPON TELEGRAPH AND TELEPHONE CORPORATION, Tokyo (JP)

(21) Appl. No.: 18/705,340

(22) PCT Filed: Oct. 29, 2021
(86) PCT No.: PCT/JP2021/040163

§ 371 Date: Apr. 26, 2024

(51) Int. Cl. H04J 3/06; G04R 20/02

(52) U.S. Cl. CPC H04J 3/0641; G04R 20/02; H04J 3/0667

(57) ABSTRACT

A boundary clock (100) as a time synchronization device according to the present disclosure includes: an offset calculation unit (102) that calculates an offset that is a difference between device internal time of a higher-level device and device internal time of an own device; a transmission delay time calculation unit (103) that calculates a transmission delay time of a packet transmitted and received between the higher-level device and the own device; and a determination unit (111) that determines an occurrence location of a failure in time synchronization with the higher-level device on the basis of the offset and the transmission delay time, and stops synchronization of device internal time of a lower-level device with the device internal time of the own device in a case where it is determined that the occurrence location of the failure is the higher-level device.

### TECHNICAL FIELD

The present disclosure relates to a time synchronization device, a time synchronization method, and a program.

### BACKGROUND ART

Precision Time Protocol (PTP) defined by the IEEE-1588 standard is a protocol that synchronizes times (device internal times) of computers on a local area network (LAN) with each other with high accuracy (see Non Patent Literature 1). FIG. 6 is a diagram illustrating a configuration example of a time synchronization system 1 that synchronizes times of devices on a network with each other by using a PTP protocol.

The time synchronization system 1 illustrated in FIG. 6 includes a grand master clock 2, a conventional boundary clock 100a, and a client device 3. The grand master clock 2 and the boundary clock 100a can communicate with each other via the network such as a LAN. In addition, the boundary clock 100a and the client device 3 can communicate with each other via the network such as a LAN.

The grand master clock 2 includes a global navigation satellite system (GNSS) antenna that receives a signal (GNSS signal) from a satellite of a GNSS such as a global positioning system (GPS). The grand master clock 2 receives the GNSS signal via the GNSS antenna, and acquires universal time coordinated (UTC) from the received GNSS signal. The grand master clock 2 has a master function of distributing the acquired UTC as a reference time via the network.

The boundary clock 100a functions, for a higher-level device having a master function, as a device having a slave function of synchronizing device internal time of the own device with the time distributed from the higher-level device, and functions, for a lower-level device having a slave function, as a device having a master function. In the time synchronization system 1 illustrated in FIG. 6, the boundary clock 100a functions as a device having a slave function for the grand master clock 2, and functions as a device having a master function for the client device 3. Thus, the boundary clock 100a synchronizes a device internal time of the boundary clock 100a with the time (reference time) distributed from the grand master clock 2 by transmission and reception of a PTP packet with the grand master clock 2. In addition, the boundary clock 100a distributes the device internal time to the client device 3 by transmission and reception of a PTP packet with the client device 3, and synchronizes device internal time of the client device 3 with the device internal time of the own device.

The client device 3 has a slave function of synchronizing the device internal time with time distributed from a device having a master function. In the time synchronization system 1 illustrated in FIG. 6, the client device 3 synchronizes the device internal time with the time distributed from the boundary clock 100a. The client device 3 is, for example, a base station device in a mobile phone network.

### CITATION LIST

### Non Patent Literature

Non Patent Literature 1: IEEE Std 1588TM-2019 “IEEE Standard for a Precision Clock Synchronization Protocol for Networked Measurement and Control Systems”

### SUMMARY OF INVENTION

### Technical Problem

In the time synchronization system 1 as illustrated in FIG. 6, a great difference may be generated between the device internal time of the grand master clock 2 and the device internal time of the boundary clock 100a due to a failure in the GNSS antenna included in the grand master clock 2, in the grand master clock 2 itself, or in a transmission path between the grand master clock 2 and the boundary clock 100a.

In a case where a failure has occurred in the transmission path, the time itself distributed from the grand master clock 2 is correct, and the boundary clock 100a is not synchronized with incorrect time.

On the other hand, in a case where a failure has occurred in the GNSS antenna included in the grand master clock 2 or in the grand master clock 2 itself, the time itself distributed from the grand master clock 2 may be incorrect and greatly different from the UTC. In this case, there is a possibility that the conventional boundary clock 100a is synchronized with the device internal time of the grand master clock 2 that has a large deviation, and time that is incorrect and greatly deviated from the UTC continues to be distributed to the client device 3 subordinate to the boundary clock 100a. Distribution of such incorrect time may cause device internal time of a user device subordinate to the client device 3 to become incorrect accordingly, resulting in a system failure or a communication failure. Furthermore, there is a possibility that a system failure or a communication failure occurs not only in the user device subordinate to the client device 3 but also in a user device subordinate to the client device 3 in which the device internal time is correct due to synchronization with another grand master clock 2 or boundary clock 100a. As described above, when synchronization with incorrect time occurs, there is a possibility that a problem having a great influence occurs.

It is an object of the present disclosure made in view of the above problems to provide a time synchronization device, a time synchronization method, and a program capable of reducing a possibility that device internal time of a lower-level device is synchronized with incorrect time in a case where device internal time of the own device is synchronized with time distributed from a higher-level device and the device internal time of the lower-level device is synchronized with the device internal time of the own device.

### Solution to Problem

In order to solve the above problems, the present disclosure provides a time synchronization device that synchronizes device internal time of an own device with device internal time of a higher-level device and synchronizes device internal time of a lower-level device with the device internal time of the own device by transmission and reception of a packet with the higher-level device, the time synchronization device including: an offset calculation unit that calculates an offset that is a difference between the device internal time of the higher-level device and the device internal time of the own device; a transmission delay time calculation unit that calculates a transmission delay time of a packet transmitted and received between the higher-level device and the own device; and a determination unit that determines an occurrence location of a failure in time synchronization with the higher-level device on the basis of the offset and the transmission delay time, and stops the synchronization of the device internal time of the lower-level device with the device internal time of the own device in a case where it is determined that the occurrence location of the failure is the higher-level device.

Furthermore, in order to solve the above problems, the present disclosure provides a time synchronization method of synchronizing device internal time of an own device with device internal time of a higher-level device and synchronizing device internal time of a lower-level device with the device internal time of the own device by transmission and reception of a packet with the higher-level device, the time synchronization method including: a step of calculating an offset that is a difference between the device internal time of the higher-level device and the device internal time of the own device; a step of calculating a transmission delay time of a packet transmitted and received between the higher-level device and the own device; and a step of determining an occurrence location of a failure in time synchronization with the higher-level device on the basis of the offset and the transmission delay time, and stopping the synchronization of the device internal time of the lower-level device with the device internal time of the own device in a case where it is determined that the occurrence location of the failure is the higher-level device.

Furthermore, in order to solve the above problems, a program according to the present disclosure causes a computer to operate as the time synchronization device described above.

### Advantageous Effects of Invention

According to the time synchronization device, the time synchronization method, and the program according to the present disclosure, in a case where device internal time of the own device is synchronized with time distributed from a higher-level device and device internal time of a lower-level device is synchronized with the device internal time of the own device, it is possible to reduce the possibility that the device internal time of the lower-level device is synchronized with incorrect time.

### BRIEF DESCRIPTION OF DRAWINGS

FIG. 1 is a diagram illustrating a configuration example of a boundary clock as a time synchronization device according to an embodiment of the present disclosure.

FIG. 2 is a flowchart illustrating an example of an operation of the boundary clock illustrated in FIG. 1.

FIG. 3A is a diagram for illustrating a change in transmission delay time in a case where a failure has occurred in a transmission path between a grand master clock and the boundary clock.

FIG. 3B is a diagram for illustrating a change in transmission delay time in a case where a failure has occurred in the grand master clock itself.

FIG. 4 is a flowchart illustrating another example of the operation of the boundary clock illustrated in FIG. 1.

FIG. 5 is a diagram illustrating an example of a hardware configuration of the boundary clock illustrated in FIG. 1.

FIG. 6 is a diagram illustrating a configuration example of a conventional time synchronization system.

### DESCRIPTION OF EMBODIMENTS

Hereinafter, an embodiment of the present disclosure will be described with reference to the drawings.

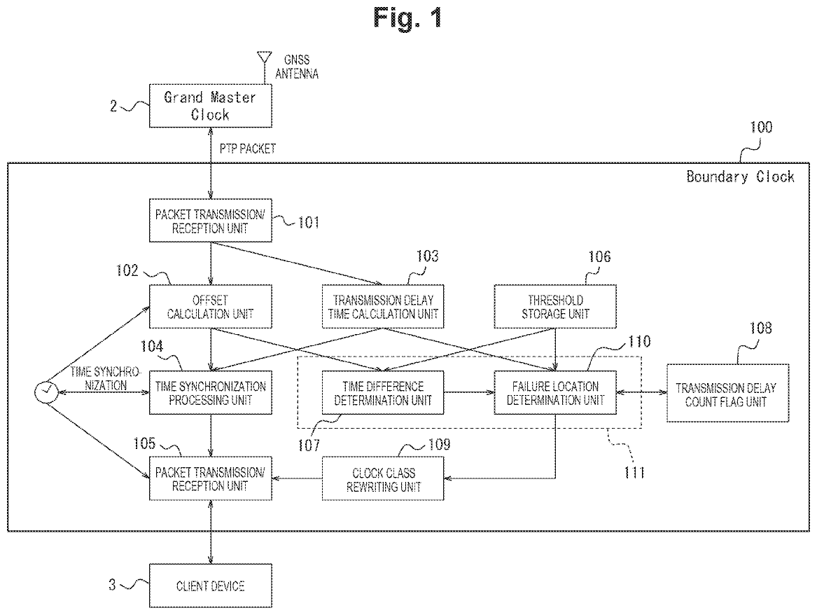

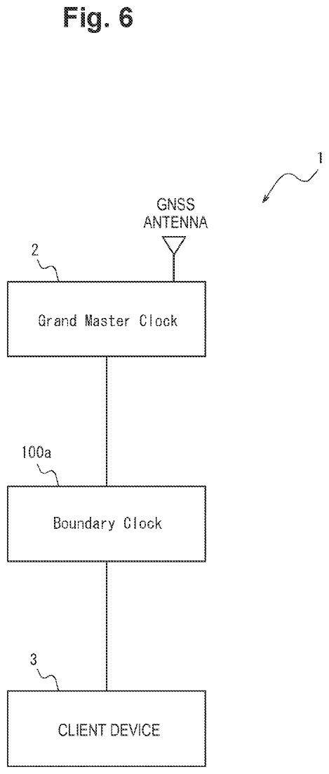

FIG. 1 is a diagram illustrating a configuration example of a boundary clock 100 as a time synchronization device according to an embodiment of the present disclosure. The boundary clock 100 according to the present embodiment, instead of the boundary clock 100a, distributes time distributed from the grand master clock 2 to the client device 3 in the time synchronization system 1 illustrated in FIG. 6. That is, the boundary clock 100 as the time synchronization device according to the present embodiment transmits and receives a packet (PTP packet) to and from a higher-level device (grand master clock 2) to synchronize device internal time of the own device with device internal time of the higher-level device and synchronize device internal time of a lower-level device (client device 3) with the device internal time of the own device.

As illustrated in FIG. 1, the boundary clock 100 according to the present embodiment includes packet transmission/reception units 101 and 105, an offset calculation unit 102, a transmission delay time calculation unit 103, a time synchronization processing unit 104, a threshold storage unit 106, a time difference determination unit 107, a transmission delay count flag unit 108, a clock class rewriting unit 109, and a failure location determination unit 110. The time difference determination unit 107 and the failure location determination unit 110 constitute a determination unit 111.

The packet transmission/reception unit 101 performs transmission and reception of a PTP packet with the grand master clock 2. The packet transmission/reception unit 101 outputs a packet received from the grand master clock 2 to the offset calculation unit 102 and the transmission delay time calculation unit 103.

The offset calculation unit 102 calculates an offset that is a difference between the device internal time of the grand master clock 2, which is a higher-level device, and the device internal time of the own device (boundary clock 100). Specifically, the offset calculation unit 102 acquires time stamps from packets output from the packet transmission/reception unit 101, and calculates the offset on the basis of the acquired time stamps. Hereinafter, calculation of the offset by the offset calculation unit 102 will be described.

The grand master clock 2 transmits a Sync message (synchronization message) to the boundary clock 100. The grand master clock 2 includes, in the Sync message, a time stamp indicating time T1 that is the time of transmission of the Sync message, and transmits the Sync message to the boundary clock 100.

When receiving the Sync message transmitted from the grand master clock 2 at time T2, the boundary clock 100 transmits a Delay_Req message (delay request message) to the grand master clock 2 at time T3. The boundary clock 100 includes, in the Delay_Req message, a time stamp indicating time T3 that is the time of transmission of the Delay_Req message, and transmits the Delay_Req message to the grand master clock 2.

When receiving the Delay_Req message transmitted from the boundary clock 100 at time T4, the grand master clock 2 transmits a Delay_Resp message (delay response message) to the boundary clock 100. The grand master clock 2 includes, in the Delay_Resp message, a time stamp indicating time T4 that is the time of reception of the Delay_Req message, and transmits the Delay_Resp message to the boundary clock 100.

The offset calculation unit 102 acquires the time stamps indicating times T1, T3, and T4 included in the PTP packets (Sync message, Delay_Req message, and Delay_Resp message) transmitted and received between the grand master clock 2 and the boundary clock 100. In addition, the offset calculation unit 102 acquires time T2 at which the boundary clock 100 received the Sync message. Then, the offset calculation unit 102 calculates the offset on the basis of the following formula.

Offset=((T2−T1)−(T4−T3))/2

The offset calculation unit 102 outputs a result of the calculation of the offset to the time synchronization processing unit 104 and the time difference determination unit 107.

The transmission delay time calculation unit 103 calculates a transmission delay time of a PTP packet transmitted and received between the grand master clock 2, which is a higher-level device, and the boundary clock 100. For example, the transmission delay time calculation unit 103 calculates, as the transmission delay time, an average of a difference between time T2 at which the boundary clock 100 received the Sync message and time T1 at which the grand master clock 2 transmitted the Sync message, and a difference between time T4 at which the grand master clock 2 received the Delay_Req message and time T3 at which the boundary clock 100 transmitted the Delay_Req message. That is, the transmission delay time calculation unit 103 calculates the transmission delay time on the basis of the following formula.

Transmission delay time=((T2−T1)+(T4−T3))/2

The transmission delay time calculation unit 103 outputs a result of the calculation of the transmission delay time to the time synchronization processing unit 104 and the failure location determination unit 110.

The time synchronization processing unit 104 synchronizes the device internal time of the boundary clock 100 with the device internal time of the grand master clock 2 on the basis of the offset calculated by the offset calculation unit 102 and the transmission delay time calculated by the transmission delay time calculation unit 103.

The packet transmission/reception unit 105 performs transmission and reception of a PTP packet with the client device 3. A packet transmitted to and received from the client device 3 includes time information indicating the device internal time of the boundary clock 100, and it is possible to synchronize the device internal time of the client device 3 with the device internal time of the boundary clock 100 by transmission and reception of the packet.

The threshold storage unit 106 stores thresholds (first threshold TH1, second threshold TH2, and third threshold TH3) necessary for processing in the time difference determination unit 107 and the failure location determination unit 110 to be described later. Examples of a method of setting the first threshold TH1, the second threshold TH2, and the third threshold TH3 include a method of setting a predetermined fixed value, and a method of acquiring data regarding offsets and transmission delay times in a certain period of time and setting average values thereof.

The time difference determination unit 107 determines whether an absolute value of the offset calculated by the offset calculation unit 102 is greater than the first threshold TH1. In a case where it is determined that the offset is greater than the first threshold TH1, the time difference determination unit 107 notifies the failure location determination unit 110 of generation of a difference between the device internal time of the grand master clock 2 and the device internal time of the own device (occurrence of a failure in time synchronization with the grand master clock 2).

The transmission delay count flag unit 108 manages a transmission delay count flag, which is a flag for counting a time period or the number of times for which the transmission delay time is continuously greater than the second threshold TH2 to be described later.

Under the control of the failure location determination unit 110, the clock class rewriting unit 109 rewrites a clock class indicating whether the device internal time of the boundary clock 100 is synchronized with the device internal time of the grand master clock 2, and outputs the clock class to the packet transmission/reception unit 105. The clock class is included in a PTP packet transmitted and received between the boundary clock 100 and the client device 3, and is transmitted to the client device 3. In the client device 3, in a case where the clock class indicates that the device internal time of the boundary clock 100 is synchronized with the device internal time of the grand master clock 2, synchronization of the device internal time of the client device 3 with the device internal time of the boundary clock 100 is performed. In a case where the clock class indicates that the device internal time of the boundary clock 100 is not synchronized with the device internal time of the grand master clock 2, the synchronization of the device internal time of the client device 3 with the device internal time of the boundary clock 100 is stopped.

Upon receiving the notification from the time difference determination unit 107, the failure location determination unit 110 determines an occurrence location of a failure in time synchronization with the grand master clock 2, which is a higher-level device, on the basis of the transmission delay time calculated by the transmission delay time calculation unit 103.

Possible occurrence locations of a failure in time synchronization include the GNSS antenna included in the grand master clock 2, the grand master clock 2 itself, or a transmission path between the grand master clock 2 and the boundary clock 100. In a case where the occurrence location of the failure is the GNSS antenna, it is considered that a signal attack such as jamming (jamming radio waves) or spoofing (impersonation) has been received. In a case where the occurrence location of the failure is the grand master clock 2 itself, it is considered that the function in the grand master clock 2 has partially failed. In a case where the occurrence location of the failure is the transmission path between the grand master clock 2 and the boundary clock 100, for example, it is considered that a cable abnormality has temporarily occurred. The failure location determination unit 110 determines whether the occurrence location of the failure is the grand master clock 2 (the GNSS antenna included in the grand master clock 2, or the grand master clock 2 itself) or the transmission path between the grand master clock 2 and the boundary clock 100. Details of the determination of the failure location by the failure location determination unit 110 will be described later.

In a case where it is determined that the occurrence location of the failure is the grand master clock 2, the failure location determination unit 110 stops synchronization of the device internal time of the client device 3 with the device internal time of the own device. Specifically, the failure location determination unit 110 instructs the clock class rewriting unit 109 to rewrite the clock class so that the clock class indicates that the device internal time of the boundary clock 100 is not synchronized with the device internal time of the grand master clock 2.

As described above, the time difference determination unit 107 and the failure location determination unit 110 constitute the determination unit 111. Therefore, on the basis of the offset and the transmission delay time, the determination unit 111 determines an occurrence location of a failure in time synchronization with the grand master clock 2, which is a higher-level device, and in a case where it is determined that the occurrence location of the failure is the grand master clock 2, synchronization of the device internal time of the client device 3, which is a lower-level device, with the device internal time of the own device is stopped.

Next, the operation of the boundary clock 100 according to the present embodiment will be described.

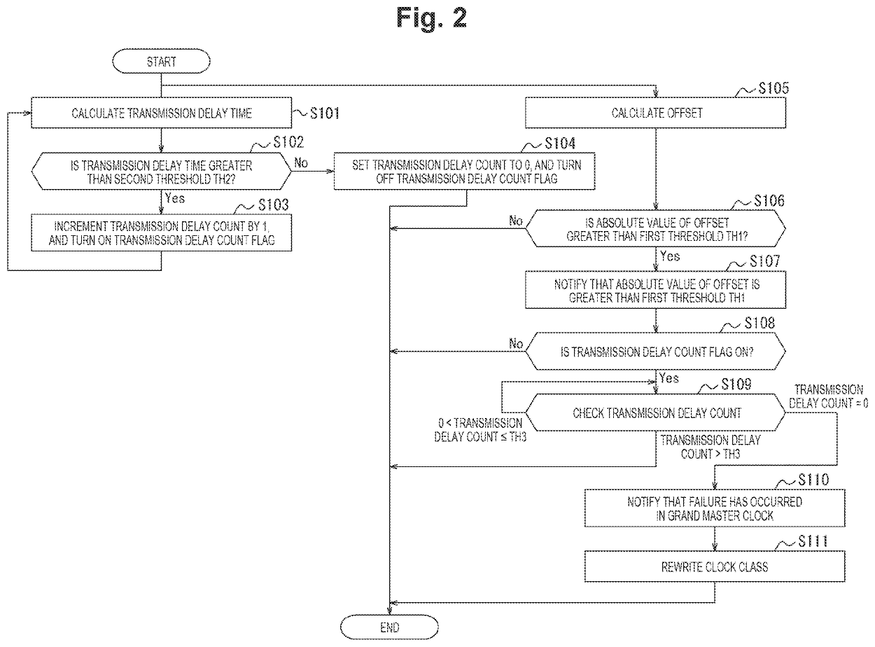

FIG. 2 is a flowchart illustrating an example of the operation of the boundary clock 100 according to the present embodiment, and is a diagram for illustrating a time synchronization method by the boundary clock 100.

The transmission delay time calculation unit 103 acquires time stamps from packets output from the packet transmission/reception unit 101, and calculates a transmission delay time (step S101).

The failure location determination unit 110 determines whether the transmission delay time calculated by the transmission delay time calculation unit 103 is greater than the second threshold TH2 stored in the threshold storage unit 106 (step S102). The second threshold TH2 is a threshold for determining whether the transmission delay time has greatly changed. For example, in a case where the grand master clock 2 and the boundary clock 100 normally transmit and receive PTP packets within 10 ns, the second threshold TH2 is set to 10 ns, for example. In this case, the failure location determination unit 110 sequentially determines whether the transmission delay time is greater than 10 ns.

As described above, an average value of pieces of data in a certain period of time may be set as the second threshold TH2. For example, the transmission delay time may be calculated every 1 second during 1 minute from the start of communication by PTP between the grand master clock 2 and the boundary clock 100, and an average value of the 60 pieces of data may be set as the second threshold TH2.

The failure location determination unit 110 counts the number of times the transmission delay time is continuously determined to be greater than the second threshold TH2. This count value is hereinafter referred to as a transmission delay count.

In a case where it is determined that the transmission delay time is greater than the second threshold TH2 (step S102: Yes), the failure location determination unit 110 increments the transmission delay count by 1, and turns on the transmission delay count flag managed by the transmission delay count flag unit 108 (step S103). In a case where the transmission delay count flag is already on, the failure location determination unit 110 keeps the transmission delay count flag on. After the processing of step S103, the processing is repeated from step S101.

In a case where it is determined that the transmission delay time is not greater than the second threshold TH2 (the transmission delay time is equal to or less than the second threshold TH2) (step S102: No), the failure location determination unit 110 sets the transmission delay count to 0 and turns off the transmission delay count flag (step S104). In a case where the transmission delay time is equal to or less than the second threshold TH2, there is no abnormality in the transmission delay time, and thus the boundary clock 100 ends the processing.

In parallel with the processing from step S101 to step S104 described above, processing from step S105 described below is performed.

The offset calculation unit 102 acquires time stamps from packets output from the packet transmission/reception unit 101, and calculates an offset (step S105).

The time difference determination unit 107 determines whether the absolute value of the offset calculated by the offset calculation unit 102 is greater than the first threshold TH1 stored in the threshold storage unit 106 (step S106). The first threshold TH1 is a threshold for determining whether the offset has greatly changed. For example, in a case where the offset between the device internal time of the grand master clock 2 and the device internal time of the boundary clock 100 is normally smaller than 1 ms, the first threshold TH1 is set to 1 ms, for example. In this case, the time difference determination unit 107 sequentially determines whether the absolute value of the offset is greater than 1 ms.

As described above, an average value of pieces of data in a certain period of time may be set as the first threshold TH1. For example, the offset may be calculated every 1 second during 1 minute from the start of communication by PTP between the grand master clock 2 and the boundary clock 100, and an average value of the 60 pieces of data may be set as the first threshold TH1.

In a case where it is determined that the absolute value of the offset is not greater than the first threshold TH1 (the offset is equal to or less than the first threshold TH1) (step S106: No), there is no abnormality in the offset, and thus the boundary clock 100 ends the processing.

In a case where it is determined that the absolute value of the offset is greater than the first threshold TH1 (step S106: Yes), the time difference determination unit 107 notifies the failure location determination unit 110 that the absolute value of the offset is greater than the first threshold TH1 (step S107). That is, the time difference determination unit 107 notifies the failure location determination unit 110 of occurrence of a failure in time synchronization between the device internal time of the grand master clock 2 and the device internal time of the boundary clock 100, which is the own device.

Upon receiving the notification from the time difference determination unit 107, the failure location determination unit 110 determines whether the transmission delay count flag is on (step S108).

In a case where it is determined that the transmission delay count flag is not on (the transmission delay count flag is off) (step S108: No), the failure location determination unit 110 ends the processing.

In a case where it is determined that the transmission delay count flag is on (step S108: Yes), the failure location determination unit 110 checks the transmission delay count (step S109).

In a case where the transmission delay count is greater than 0 and equal to or less than the third threshold TH3 stored in the threshold storage unit 106 (0<transmission delay count≤third threshold TH3), the failure location determination unit 110 repeats the processing of step S109. The third threshold TH3 is a threshold for determining whether the change in the transmission delay time is temporary. The third threshold TH3 is set to 10 times, for example. In this case, the failure location determination unit 110 determines whether the transmission delay time is continuously greater than the second threshold TH2 (e.g., 10 ms) 10 times.

In a case where it is determined that the transmission delay count is greater than the third threshold TH3 (transmission delay count>third threshold TH3), the failure location determination unit 110 ends the processing.

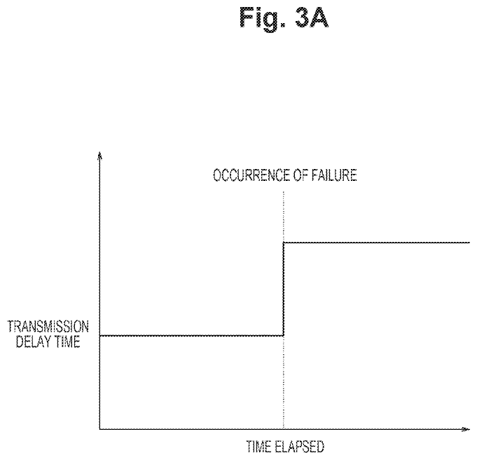

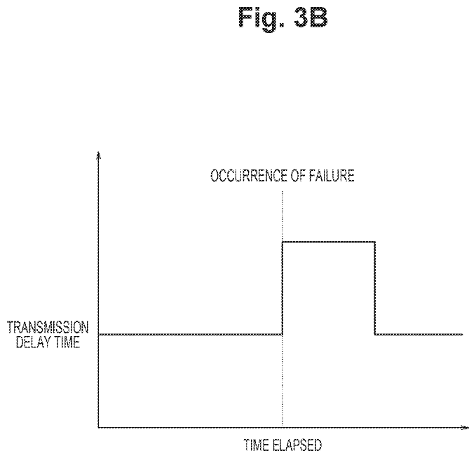

FIG. 3A is a diagram for illustrating a change in transmission delay time in a case where a failure has occurred in the transmission path between the grand master clock 2 and the boundary clock 100.

As illustrated in FIG. 3A, in a case where a failure has occurred in the transmission path between the grand master clock 2 and the boundary clock 100, the time transmitted from the grand master clock 2 by PTP is correct, but the transmission delay time greatly changes due to the failure in the transmission path. In addition, the device internal time of the grand master clock 2 and the device internal time of the boundary clock 100 remain correct and the failure in the transmission path persists, and thus the transmission delay time becomes constant and does not return to the original value before the occurrence of the failure as illustrated in FIG. 3A. Therefore, in a case where the offset is greater than the first threshold TH1 and the transmission delay time does not return to the original state within a predetermined time (third threshold TH3) after the transmission delay time has greatly changed (the transmission delay time has become greater than the second threshold TH2), the failure location determination unit 110 can determine that a failure has occurred in the transmission path between the grand master clock 2 and the boundary clock 100.

In a case where a failure has occurred in the transmission path between the grand master clock 2 and the boundary clock 100, the device internal time of the grand master clock 2 and the device internal time of the boundary clock 100 are correct, and thus synchronizing the device internal time of the client device 3 with the device internal time of the boundary clock 100 does not cause any problem. Therefore, in a case where it is determined that the occurrence location of the failure is the transmission path between the grand master clock 2 and the boundary clock 100, the failure location determination unit 110 continuously synchronizes the device internal time of the client device 3 with the device internal time of the boundary clock 100 without rewriting the clock class.

Referring back to FIG. 2, in a case where the transmission delay count becomes 0 before the transmission delay count becomes greater than the third threshold TH3, the failure location determination unit 110 determines that a failure has occurred in the grand master clock 2. Then, the failure location determination unit 110 notifies the clock class rewriting unit 109 that a failure has occurred in the grand master clock 2 (step S110). Upon receiving the notification from the failure location determination unit 110, the clock class rewriting unit 109 rewrites the clock class so that the clock class indicates that the device internal time of the boundary clock 100 is not synchronized with the device internal time of the grand master clock 2. As a result, the synchronization of the device internal time of the client device 3 with the device internal time of the boundary clock 100 is stopped.

FIG. 3B is a diagram for illustrating a change in transmission delay time in a case where a failure has occurred in the grand master clock 2 (the GNSS antenna included in the grand master clock 2 or the grand master clock 2 itself).

As illustrated in FIG. 3B, in a case where a failure has occurred in the grand master clock 2, the time transmitted from the grand master clock 2 by PTP is incorrect, and thus the transmission delay time greatly changes. However, after a while, the device internal time of the boundary clock 100 is synchronized with the incorrect time transmitted from the grand master clock 2, so that the transmission delay time returns to the original value before the occurrence of the failure. Therefore, in a case where the offset is greater than the first threshold TH1 and the transmission delay time has greatly changed and then returned to the original state within a predetermined time, the failure location determination unit 110 can determine that a failure has occurred in the grand master clock 2.

In a case where a failure has occurred in the grand master clock 2, the time distributed from the grand master clock 2 is incorrect, and synchronizing the device internal time of the client device 3 with that time may cause an adverse effect such as a system failure or a communication failure. Therefore, in a case where it is determined that the occurrence location of the failure is the grand master clock 2, the failure location determination unit 110 rewrites the clock class and stops the synchronization of the device internal time of the client device 3 with the device internal time of the boundary clock 100.

In FIG. 2, an example in which the third threshold TH3 is the number of times the transmission delay time is determined to be greater than the second threshold TH2 has been described, but the present invention is not limited thereto. The third threshold TH3 may be a time period for which the transmission delay time is determined to be continuously greater than the second threshold TH2.

As described above, the time synchronization method according to the present embodiment includes: a step of calculating, by the offset calculation unit 102, an offset that is a difference between the device internal time of the grand master clock 2, which is a higher-level device, and the device internal time of the boundary clock 100 (step S105); and a step of calculating, by the transmission delay time calculation unit 103, a transmission delay time of a packet transmitted and received between the grand master clock 2 and the boundary clock 100 (step S101). The time synchronization method according to the present embodiment further includes a step, which is performed by the determination unit 111 constituted by the time difference determination unit 107 and the failure location determination unit 110, of determining an occurrence location of a failure in time synchronization with the grand master clock 2 on the basis of the offset and the transmission delay time (steps S102 to S104 and S106 to S109), and stopping synchronization of the device internal time of the client device 3, which is a lower-level device, with the device internal time of the boundary clock 100 in a case where it is determined that the occurrence location of the failure is the grand master clock 2 (step S110).

Specifically, the determination unit 111 determines whether the offset is greater than the first threshold TH1 and whether the transmission delay time is greater than the second threshold TH2 (steps S102 and S106). Then, in a case where the offset is greater than the first threshold TH1 (step S106: Yes) and the transmission delay time has become equal to or less than the second threshold TH2 (transmission delay count=0 in step S109) before the number of times or the time period for which the transmission delay time has been determined to be greater than the second threshold TH2 becomes greater than the third threshold TH3, the determination unit 111 determines that the occurrence location of the failure is the grand master clock 2, and stops the synchronization of the device internal time of the client device 3 with the device internal time of the boundary clock 100 (step S110).

In a case where the number of times or the time period for which the transmission delay time has been determined to be greater than the second threshold TH2 has become greater than the third threshold TH3 (transmission delay count>3 in step S109), the determination unit 111 synchronizes the device internal time of the client device 3 with the device internal time of the boundary clock 100 without rewriting the clock class.

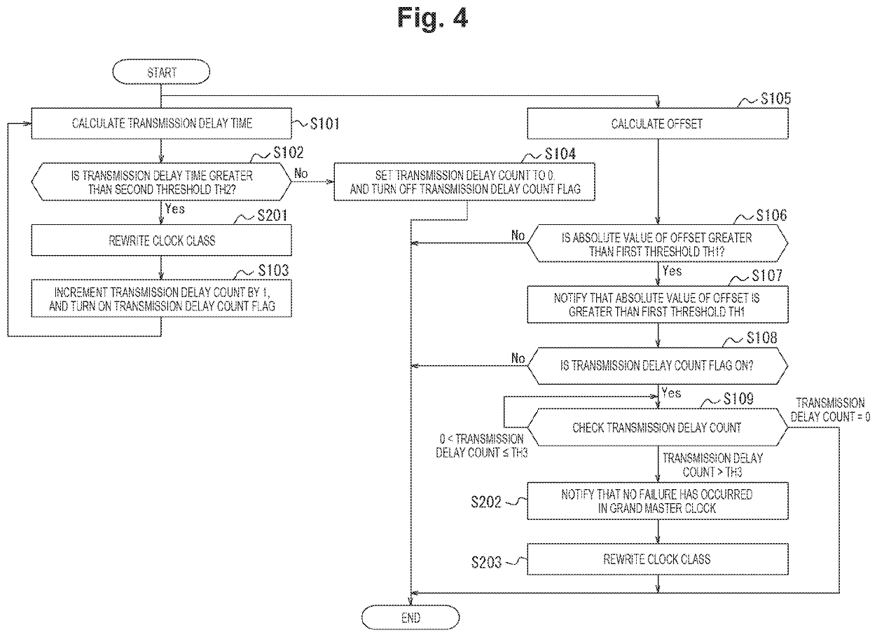

In FIG. 2, the clock class is rewritten after determination of whether the number of times or the time period for which the transmission delay time has been determined to be greater than the second threshold TH2 is greater than the third threshold TH3. Thus, it takes time to switch whether or not to synchronize the device internal time of the client device 3 with the device internal time of the boundary clock 100. Thus, the determination unit 111 may perform processing of rewriting the clock class immediately after the transmission delay time has become greater than the second threshold TH2, and then rewriting the clock class again (returning the clock class to the original state) when it is determined that the occurrence location of the failure is the transmission path between the grand master clock 2 and the boundary clock 100 (the occurrence location of the failure is not the grand master clock 2). FIG. 4 is a flowchart illustrating an example of the operation of the boundary clock 100 in a case where such processing is performed. In FIG. 4, pieces of processing similar to those in FIG. 2 are denoted by the same reference numerals, and description thereof will be omitted.

Comparing FIG. 4 with FIG. 2, the processing of steps S110 and S111 is deleted, and the processing of steps S201, S202, and S203 is added. Hereinafter, processing of steps S201, S202, and S203 will be mainly described.

In a case where it is determined that the transmission delay time is greater than the second threshold TH2 (step S102: Yes), the failure location determination unit 110 provisionally determines that a failure has occurred in the grand master clock 2. Then, the failure location determination unit 110 notifies the clock class rewriting unit 109 that a failure has occurred in the grand master clock 2 (step S201). Upon receiving the notification from the failure location determination unit 110, the clock class rewriting unit 109 rewrites the clock class so that the clock class indicates that the device internal time of the boundary clock 100 is not synchronized with the device internal time of the grand master clock 2. As a result, the synchronization of the device internal time of the client device 3 with the device internal time of the boundary clock 100 is stopped.

The failure location determination unit 110 checks the transmission delay count (step S109), and when the transmission delay count becomes greater than the third threshold TH3 (transmission delay count>third threshold TH3), determines that the occurrence location of the failure is the transmission path between the grand master clock 2 and the boundary clock 100 (the occurrence location of the failure is not the grand master clock 2), and notifies the clock class rewriting unit 109 that no failure has occurred in the grand master clock 2 (step S202).

Upon receiving the notification from the failure location determination unit 110, the clock class rewriting unit 109 rewrites the clock class again (returns the clock class to the original state) (step S203). Thus, the synchronization of the device internal time of the client device 3 with the device internal time of the boundary clock 100 is resumed.

As described above, in a case where the transmission delay count becomes 0 before the transmission delay count becomes greater than the third threshold TH3, the failure location determination unit 110 determines that a failure has occurred in the grand master clock 2. In this case, the synchronization of the device internal time of the client device 3 with the device internal time of the boundary clock 100 has been stopped, and the failure location determination unit 110 ends the processing as it is.

In this manner, the determination unit 111 constituted by the time difference determination unit 107 and the failure location determination unit 110 determines whether the offset is greater than the first threshold TH1 and whether the transmission delay time is greater than the second threshold TH2. Then, in a case where the transmission delay time is greater than the second threshold TH2, the determination unit 111 may stop the synchronization of the device internal time of the client device 3 with the device internal time of the boundary clock 100. Furthermore, in a case where the offset is greater than the first threshold TH1 and the number of times or the time period for which the transmission delay time has been determined to be greater than the second threshold TH2 becomes greater than the third threshold TH3 in a state where the synchronization of the device internal time of the client device 3 with the device internal time of the boundary clock 100 has been stopped, the determination unit 111 may synchronize the device internal time of the client device 3 with the device internal time of the boundary clock 100.

As described above, the boundary clock 100 as the time synchronization device according to the present embodiment includes the offset calculation unit 102, the transmission delay time calculation unit 103, and the determination unit 111. The offset calculation unit 102 calculates an offset that is a difference between the device internal time of the grand master clock 2, which is a higher-level device, and the device internal time of the own device. The transmission delay time calculation unit 103 calculates a transmission delay time of a packet transmitted and received between the grand master clock 2 and the boundary clock 100. On the basis of the offset and the transmission delay time, the determination unit 111 determines an occurrence location of a failure in time synchronization with the grand master clock 2, and in a case where it is determined that the occurrence location of the failure is the grand master clock 2, synchronization of the device internal time of the client device 3, which is a lower-level device, with the device internal time of the own device is stopped.

In a case where the occurrence location of the failure is the grand master clock 2, the time distributed from the grand master clock 2 is incorrect. In a case where the device internal time of the own device is synchronized with that time and the device internal time of the client device 3 is synchronized with the device internal time of the own device, the incorrect time is distributed to the client device 3. Thus, in the present embodiment, the boundary clock 100 stops synchronization of the device internal time of the client device 3 with the device internal time of the own device in a case where it is determined that the occurrence location of the failure is the grand master clock 2 on the basis of the offset and the transmission delay time. Accordingly, in a case where device internal time of the own device is synchronized with time distributed from a higher-level device and device internal time of a lower-level device is synchronized with the device internal time of the own device, it is possible to reduce the possibility that the device internal time of the lower-level device is synchronized with incorrect time.

In the present embodiment, an example in which the time synchronization device according to the present disclosure performs time synchronization between the grand master clock 2 and the client device 3 has been described, but the present invention is not limited thereto. The time synchronization device according to the present disclosure may perform time synchronization between one boundary clock and another boundary clock, for example.

Next, a hardware configuration of the boundary clock 100 as the time synchronization device according to the present embodiment will be described.

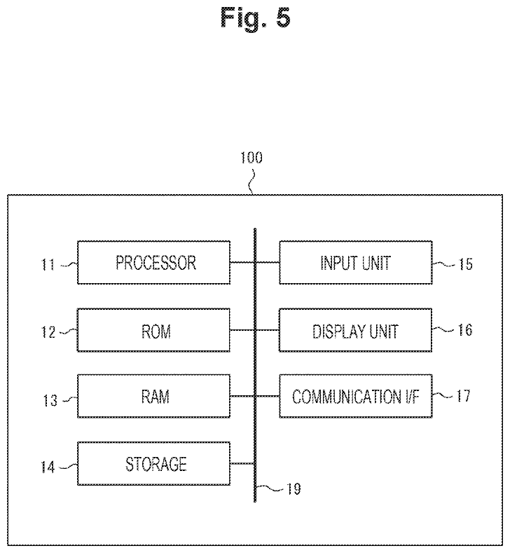

FIG. 5 is a diagram illustrating an example of the hardware configuration of the boundary clock 100 as the time synchronization device according to the present embodiment. The example of the hardware configuration of the boundary clock 100 illustrated in FIG. 5 shows a case where the boundary clock 100 is configured by a computer capable of executing a program instruction. Here, the computer may be a general-purpose computer, a dedicated computer, a workstation, a personal computer (PC), an electronic notepad, or the like. The program instruction may be a program code, a code segment, or the like for executing required tasks.

As illustrated in FIG. 5, the boundary clock 100 includes a processor 11, a read only memory (ROM) 12, a random access memory (RAM) 13, a storage 14, an input unit 15, a display unit 16, and a communication interface (I/F) 17. The components are communicatively connected to each other via a bus 19. Specifically, the processor 11 is a central processing unit (CPU), a micro processing unit (MPU), a graphics processing unit (GPU), a digital signal processor (DSP), a system on a chip (SoC), or the like, and may be configured by a plurality of processors of the same type or different types.

The processor 11 is a control unit that executes control of the components and various types of arithmetic processing. That is, the processor 11 reads a program from the ROM 12 or the storage 14 and executes the program using the RAM 13 as a work area. The processor 11 executes control of the above components and various types of arithmetic processing in accordance with a program stored in the ROM 12 or the storage 14. In the present embodiment, the ROM 12 or the storage 14 stores a program for causing a computer to function as the boundary clock 100 according to the present disclosure. The program is read and executed by the processor 11 to implement the components of the boundary clock 100, that is, the offset calculation unit 102, the transmission delay time calculation unit 103, the time synchronization processing unit 104, the time difference determination unit 107, the transmission delay count flag unit 108, the clock class rewriting unit 109, and the failure location determination unit 110.

The program may be provided in a form in which the program is stored in a non-transitory storage medium, such as a compact disk read only memory (CD-ROM), a digital versatile disk read only memory (DVD-ROM), or a universal serial bus (USB) memory. In addition, the program may be downloaded from an external device via a network.

The ROM 12 stores various programs and various types of data. The RAM 13 as a work area temporarily stores programs or data. The storage 14 includes a hard disk drive (HDD) or a solid state drive (SSD) and stores various programs including an operating system and various types of data. The ROM 12 or the storage 14 stores, for example, the first threshold TH1, the second threshold TH2, and the third threshold TH3 described above.

The input unit 15 includes a pointing device such as a mouse and a keyboard and is used to perform various inputs.

The display unit 16 is, for example, a liquid crystal display and displays various types of information. The display unit 16 may function as the input unit 15 by employing a touchscreen system.

The communication interface 17 is an interface for communicating with another device (e.g., the grand master clock 2 and the client device 3), and is, for example, an interface for LAN.

A computer can be suitably used to function as each unit of the boundary clock 100 described above. Such a computer can be implemented by storing a program in which processing contents for implementing the function of each unit of the boundary clock 100 are written in a storage unit of the computer and causing a processor of the computer to read and execute the program. That is, the program can cause the computer to function as the boundary clock 100 described above. The program can also be recorded in a non-transitory storage medium. In addition, the program can also be provided via a network.

Regarding the above embodiment, the following supplementary notes are further disclosed.

### [Supplementary Note 1]

A time synchronization device that synchronizes device internal time of an own device with device internal time of a higher-level device and synchronizes device internal time of a lower-level device with the device internal time of the own device by transmission and reception of a packet with the higher-level device, the time synchronization device including:
a memory; and
a control unit connected to the memory,
in which the control unit
calculates an offset that is a difference between the device internal time of the higher-level device and the device internal time of the own device,
calculates a transmission delay time of a packet transmitted and received between the higher-level device and the own device, and
determines an occurrence location of a failure in time synchronization with the higher-level device on the basis of the offset and the transmission delay time, and stops the synchronization of the device internal time of the lower-level device with the device internal time of the own device in a case where it is determined that the occurrence location of the failure is the higher-level device.

### [Supplementary Note 2]

The time synchronization device according to supplementary note 1, in which
the control unit determines whether the offset is greater than a first threshold and whether the transmission delay time is greater than a second threshold, and stops the synchronization of the device internal time of the lower-level device with the device internal time of the own device in a case where the offset is greater than the first threshold and the transmission delay time has become equal to or less than the second threshold before the number of times or a time period for which the transmission delay time has been determined to be greater than the second threshold becomes greater than a third threshold.

### [Supplementary Note 3]

The time synchronization device according to supplementary note 2, in which
the control unit synchronizes the device internal time of the lower-level device with the device internal time of the own device in a case where the number of times or the time period for which the transmission delay time has been determined to be greater than the second threshold has become greater than the third threshold.

### [Supplementary Note 4]

The time synchronization device according to supplementary note 1, in which
the control unit determines whether the offset is greater than a first threshold and whether the transmission delay time is greater than a second threshold, and stops the synchronization of the device internal time of the lower-level device with the device internal time of the own device in a case where the transmission delay time is greater than the second threshold, and
synchronizes the device internal time of the lower-level device with the device internal time of the own device in a case where the offset is greater than the first threshold and the number of times or a time period for which the transmission delay time has been determined to be greater than the second threshold becomes greater than a third threshold in a state where the synchronization of the device internal time of the lower-level device with the device internal time of the own device has been stopped.

### [Supplementary Note 5]

A time synchronization method of synchronizing device internal time of an own device with device internal time of a higher-level device and synchronizing device internal time of a lower-level device with the device internal time of the own device by transmission and reception of a packet with the higher-level device, the time synchronization method including:
calculating an offset that is a difference between the device internal time of the higher-level device and the device internal time of the own device;
calculating a transmission delay time of a packet transmitted and received between the higher-level device and the own device; and
determining an occurrence location of a failure in time synchronization with the higher-level device on the basis of the offset and the transmission delay time, and stopping the synchronization of the device internal time of the lower-level device with the device internal time of the own device in a case where it is determined that the occurrence location of the failure is the higher-level device.

### [Supplementary Note 6]

A non-transitory storage medium storing a program executable by a computer, the non-transitory storage medium storing a program that causes the computer to operate as the time synchronization device according to any one of supplementary notes 1 to 4.

While the above-described embodiment has been described as a representative example, it is apparent to those skilled in the art that many modifications and substitutions can be made within the spirit and scope of the present disclosure. Therefore, it should not be understood that the present invention is limited by the above-described embodiment, and various modifications or changes can be made without departing from the scope of the claims. For example, a plurality of configuration blocks described in the configuration diagrams of the embodiment can be combined into one, or one configuration block can be divided.

### REFERENCE SIGNS LIST

1 Time synchronization system
2 Grand master clock (higher-level device)
3 Client device (lower-level device)
11 Processor
12 ROM
13 RAM
14 Storage
15 Input unit
16 Display unit
17 Communication I/F
19 Bus
100 Boundary clock (time synchronization device)
101, 105 Packet transmission/reception unit
102 Offset calculation unit
103 Transmission delay time calculation unit
104 Time synchronization processing unit
106 Threshold storage unit
107 Time difference determination unit
108 Transmission delay count flag unit
109 Clock class rewriting unit
110 Failure location determination unit
111 Determination unit

1. A time synchronization system, the time synchronization system comprising:
at least one processor; and
memory storing instructions that, when executed by the at least one processor, causes the system to perform a set of operations, the set of operations comprising:
calculating an offset that is a difference between the device internal time of the higher-level device and the device internal time of the own device;
calculating a transmission delay time of a packet transmitted and received between the higher-level device and the own device; and
determining an occurrence location of a failure in time synchronization with the higher-level device on the basis of the offset and the transmission delay time, and stops the synchronization of the device internal time of the lower-level device with the device internal time of the own device in a case where it is determined that the occurrence location of the failure is the higher-level device.

2. The time synchronization system according to claim 1, wherein whether the offset is greater than a first threshold and whether the transmission delay time is greater than a second threshold are determined, and stops the synchronization of the device internal time of the lower-level device with the device internal time of the own device in a case where the offset is greater than the first threshold and the transmission delay time has become equal to or less than the second threshold before the number of times or a time period for which the transmission delay time has been determined to be greater than the second threshold becomes greater than a third threshold.

3. The time synchronization system according to claim 2, wherein the device internal time of the lower-level device with the device internal time of the own device is synchronized in a case where the number of times or the time period for which the transmission delay time has been determined to be greater than the second threshold has become greater than the third threshold.

4. The time synchronization system according to claim 1, wherein
whether the offset is greater than a first threshold and whether the transmission delay time is greater than a second threshold is determined, and stops the synchronization of the device internal time of the lower-level device with the device internal time of the own device in a case where the transmission delay time is greater than the second threshold, and
synchronizing the device internal time of the lower-level device with the device internal time of the own device in a case where the offset is greater than the first threshold and the number of times or a time period for which the transmission delay time has been determined to be greater than the second threshold becomes greater than a third threshold in a state where the synchronization of the device internal time of the lower-level device with the device internal time of the own device has been stopped.

5. A time synchronization method, the time synchronization method comprising:
calculating an offset that is a difference between the device internal time of the higher-level device and the device internal time of the own device;
calculating a transmission delay time of a packet transmitted and received between the higher-level device and the own device; and
determining an occurrence location of a failure in time synchronization with the higher-level device on the basis of the offset and the transmission delay time, and stopping the synchronization of the device internal time of the lower-level device with the device internal time of the own device in a case where it is determined that the occurrence location of the failure is the higher-level device.

6. (canceled)

7. A computer-readable non-transitory recording medium storing computer-executable program instructions that when executed by a processor cause a computer to execute a program generation method comprising:
calculating an offset that is a difference between the device internal time of the higher-level device and the device internal time of the own device;
calculating a transmission delay time of a packet transmitted and received between the higher-level device and the own device; and
determining an occurrence location of a failure in time synchronization with the higher-level device on the basis of the offset and the transmission delay time, and stops the synchronization of the device internal time of the lower-level device with the device internal time of the own device in a case where it is determined that the occurrence location of the failure is the higher-level device.

8. The time synchronization of claim 1, wherein the system synchronizes device internal time of an own device with device internal time of a higher-level device and synchronizes device internal time of a lower-level device with the device internal time of the own device by transmitting a packet from the higher-level device.
